(19) United States
(12) Patent Application Publication
(10) Pub. No.: US 2005/0091361 A1
(43) Pub. Date: Apr. 28, 2005

(54) Method of creating a virtual network topology for use in a graphical user interface

(76) Inventors: David R. Bernstein, Scotts Valley, CA (US); Rodrigo A. Laguisma, Cupertino, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/940,388

(22) Filed: Sep. 13, 2004

Related U.S. Application Data
(60) Provisional application No. 60/502,021, filed on Sep. 11, 2003.

(51) Int. Cl. G06F 15/173

(52) U.S. Cl. 709/223; 709/224

(57) ABSTRACT

A method of graphically depicting various network elements of a communications network in a virtual network topology via a graphical user interface (“GUI”) is disclosed. The virtual network topology depicts logical relationships between network components instead of merely depicting physical network component relationships. A system network subset and a monitoring network subset of the communications network are defined according to one layer N of the open system interconnection (“OSI”) layer model. Various logical links are established between the system network and the monitoring network. A virtual topology is defined that depicts the various logical links according to another OSI layer M. The virtual topology is displayed via a GUI that enables modification of the logical links to occur.

### CROSS-REFERENCE TO RELATED APPLICATIONS

This application claims the benefit of U.S. Provisional Patent Application No. 60/502,021, filed on Sep. 11, 2003, entitled “VIRTUAL NETWORK TOPOLOGY AS GRAPHICAL USER INTERFACE,” which is incorporated herein by reference in its entirety.

### BACKGROUND

1. Technology Field

The present invention generally relates to communications networks. In particular, the present invention is directed to methods of creating and graphically displaying virtual network topologies within a communications network in order to facilitate the manipulation thereof.

2. The Related Technology

Modem computer networks involve the transmission of large amounts of data at very high speeds across the networks. For example, in some networks, transmission rates as high as 10 Gbits/second are currently being used. Today, hardware and protocols that will support transmission rates up to 40 Gbits/second are being developed. Within these networks, transmission problems may occur intermittently.

Using network analysis tools, network administrators can identify and resolve various types of network problems. In some situations, network problems may be resolved by sampling a portion of the data transmitted across the network or by performing a statistical analysis on portions of the transmitted data. Other solutions require the collection of all data that traverses the network during a given time period.

One example of a network analysis tool mentioned above is known as a network analyzer. Network analyzers utilize a combination of hardware and software components to monitor data transmitted across the network, to capture such data upon the execution of one or more triggers, and to analyze captured data in order to diagnose or detect problem conditions existing on the network. As such, the software applications that cooperate with hardware components of the network analyzer are critical to ensure proper data traffic monitoring, capture, and problem condition diagnosis. Indeed, software applications used in this manner can be employed to view and/or manipulate various network configurations and overall topology of the physical network. Thus, these software applications are highly beneficial in maximizing utility of network analyzers and other types of network analysis tools.

As mentioned above, the use of software applications to view and manipulate physical network topologies is well known. The desire often arises, however, to view and/or manipulate other aspects of the network configuration. An example of this would include a user who wishes to examine a derived, or virtual, representation of a physical network that depicts not only physical network aspects, but logical aspects, such as the logical interconnections between network components. Indeed, it is often desirable to identify collections of links, ports, devices, and other network elements that are key to the end to end functionality of a particular application, or key to the successful traversal of traffic from one point to another point in the network. These “virtual” network paths are logical concepts that often do not exist in the actual network topology.

In light of the above discussion, a need has therefore arisen in the art for a manner by which a software application can enable a user to view and manipulate components that are represented in a virtual topology with respect to the physical configuration of a communications network. In particular, a need exists by which logical relationships between network components can be viewed and manipulated directly and graphically by a user.

### BRIEF SUMMARY

Briefly summarized, embodiments of the present invention are directed to systems and methods by which a software application can depict, for viewing and manipulation, a virtual representation of a network, a portion of a network, or a group of network components. Embodiments of the present invention are implemented within a network communications environment by a software application that operates in conjunction with one or more network analyzers or similar components for use within the communications network, though other possible applications also exist. Moreover, the virtual representation of the network is executed graphically, thereby enabling a user to visually ascertain details of the virtual communications network topology. This is accomplished utilizing a graphical user interface in connection with a computer system, such as the network analyzer.

In one embodiment of the invention, then, a method is disclosed for producing a virtual topography of a communications network. The method includes defining a first portion of a communications network having a first plurality of network components that are configured according to a first layer N of the Open System Interconnection Model; defining a second portion of the communications network having a second plurality of network components that are configured according to the first layer N; and defining a plurality of communication links between the first plurality and second plurality of network components that are configured according to the first layer N. The method further comprises constructing a virtual network having a plurality of virtual network elements that each represent at least one of the plurality of communication links, wherein the virtual network elements are configured according to a second layer M of the Open System Interconnection Model; and via a graphical user interface, depicting at least a portion of the virtual network.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram showing various details of one environment in which embodiments of the present invention can be practiced;

FIG. 2A is a simplified block diagram showing various portions of a communications network that are used according to one embodiment of the present invention;

FIG. 2B is a screen display from a display device showing a portion of a graphical user interface, used according to one embodiment;

FIG. 3 is another example of a graphical user interface according to another embodiment; and

FIG. 4 is a block diagram showing various stages of a method according to one embodiment present invention.

### DETAILED DESCRIPTION OF SELECTED EMBODIMENTS

Reference will now be made to figures wherein like structures will be provided with like reference designations. It is understood that the drawings are diagrammatic and schematic representations of exemplary embodiments of the invention, and are not limiting of the present invention nor are they necessarily drawn to scale.

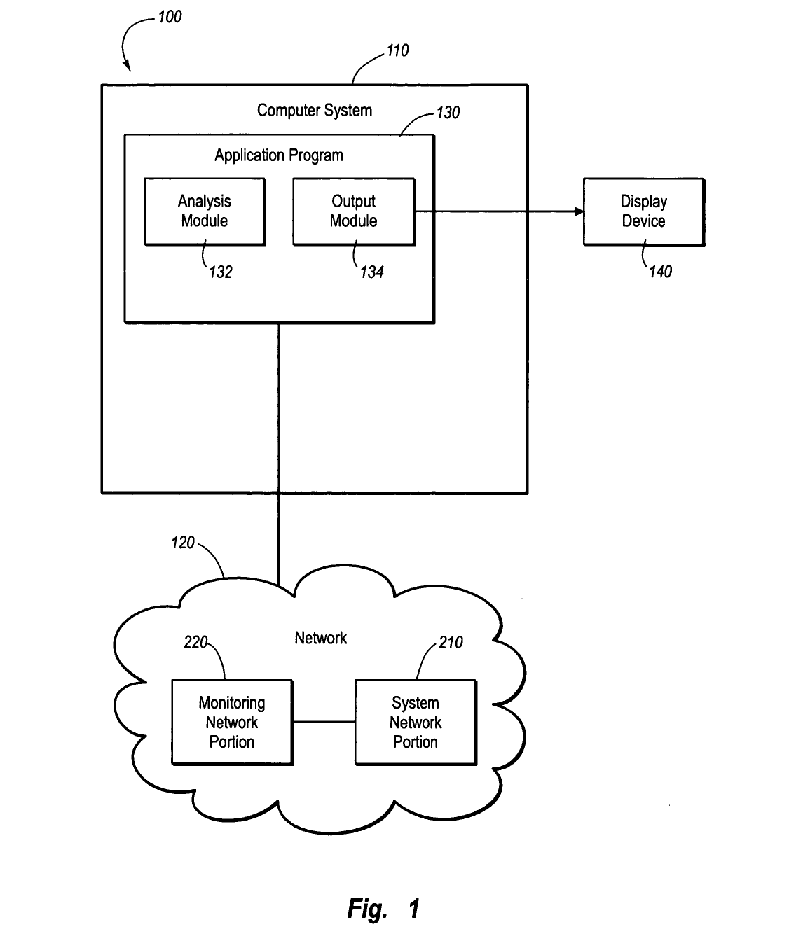

FIGS. 1-5 depict various features of embodiments of the present invention, which is generally directed to a graphical user interface (“GUI”) representation of a virtual topology of a communication network environment, and methods to achieve such a virtual representation. The virtual network topology as depicted by the GUI can be presented via a screen display or other visual display apparatus. In contrast to other known application-based network GUIs, the virtual network topology GUI depicts not purely physical aspects the network, its components, and relationships between components, but rather displays logical connections between network components. This in turn enables viewing and manipulation of such logical connections, which in turn provides enhanced utility for a user.

Reference is first made to FIG. 1, which depicts an exemplary operating environment, generally depicted at 100, in which embodiments of the present invention can be practiced. In detail, the environment 100 includes a computer system 110 that is in communication with a communications network 120. The communications network 120 can include, but is not limited to, Local Area Networks, Wide Area Networks, Storage Area Networks, the Internet, and the like or any combination thereof. The communications network 120 can also be either a wired and/or wireless network.

In one embodiment, the computer system 110 is a network analyzer or similar apparatus for monitoring network data traffic in the communications network 120 in order to detect and diagnose problems existing in the network, such as problem conditions existing between network components (not shown here), or links between components.

The computer system 110 includes an application program 130 including computer executable instructions that are included in one or more modules. For instance, in one embodiment, the application program 130 includes an analysis module 132 and an output module 134. As configured here, the analysis module 132 directs procedures and tasks associated with the monitoring of the communications network 120 by the computer system 110. Results obtained by execution of the instructions included in the analysis module 132 can be compiled and output via the output module 134. In the illustrated embodiment, data that is received and/or compiled by the output module 134 is directed to a display device 140 for visual presentation to a user (not shown).

In addition to the analysis module 132 and output module 134, other modules containing computer executable instructions can be contained within the application program 130. Indeed, the modules shown in FIG. 1 are exemplary, and it is appreciated that additional or other modules can alternatively be included in the application program 132 to accomplish similar tasks as described herein. Also, though described here as a network analyzer, the computer system 110 can include any one of a variety of computer systems, including specific or general purpose computers designed according to a particular need. In addition, embodiments of the present invention can be employed in connection with networks of various types, configurations, and purposes. Thus, the description of the various embodiments described as contained herein should not be construed as limiting the present invention in any way.

As shown in FIG. 1, the network 120 can include, for purposes of the present invention, various network subsets, or defined sub-portions of the network. For instance, as shown, the network 120 in one embodiment can include two defined sub-portions: a system network 210 and a monitoring network 220. As will be described, these network portions are defined and employed in connection with the present invention. In one embodiment, the system network and the monitor network can together comprise the entire communications network 120. In other embodiments, only portions of the communications network 120 are represented by the system network 210 and the monitoring network 220. Various details of the system network 210 and the monitoring network 220 are described below.

For purposes of the present invention, it is helpful to briefly describe various details regarding the Open System Interconnection (“OSI”) networking model which is utilized by embodiments of the present invention. In brief, the OSI model describes various layers that are utilized by a communications network in transmitting data between network components. The OSI model contains the following layers:
Layer 7—the application layer: the layer at which communication partners are identified, quality of service is identified, user authentication and privacy are considered, and any constraints on data syntax are identified.
Layer 6—the presentation layer: typically part of an operating system; converts incoming and outgoing data from one presentation format to another (e.g., converting a text stream into a pop up window containing the text); also called the syntax layer.
Layer 5—the session layer: sets up, coordinates, in terminates conversations, exchanges, dialogues between applications at opposite ends of a communication session; also deals with session and connection coordination.
Layer 4—the transport layer: manages the end to end data transfer control (e.g., determining whether all data packets have arrived), and error checking, thereby complete data transfer.
Layer 3—the network layer: handles the routing of the data (e.g., sending data in the proper direction to the proper destination on outgoing transmission and receiving incoming transmissions at the back at level); handles routing and forwarding.
Layer 2—the data link layer: provides synchronization for the physical layer (below), directs bit-stuffing; furnishes data transmission protocol knowledge and management.
Layer 1—the physical layer: conveys the data bit stream through the network at the electrical and mechanical level; provides the hardware means of sending and receiving data.
   The use of the OSI model in connection with the present invention will be described below.

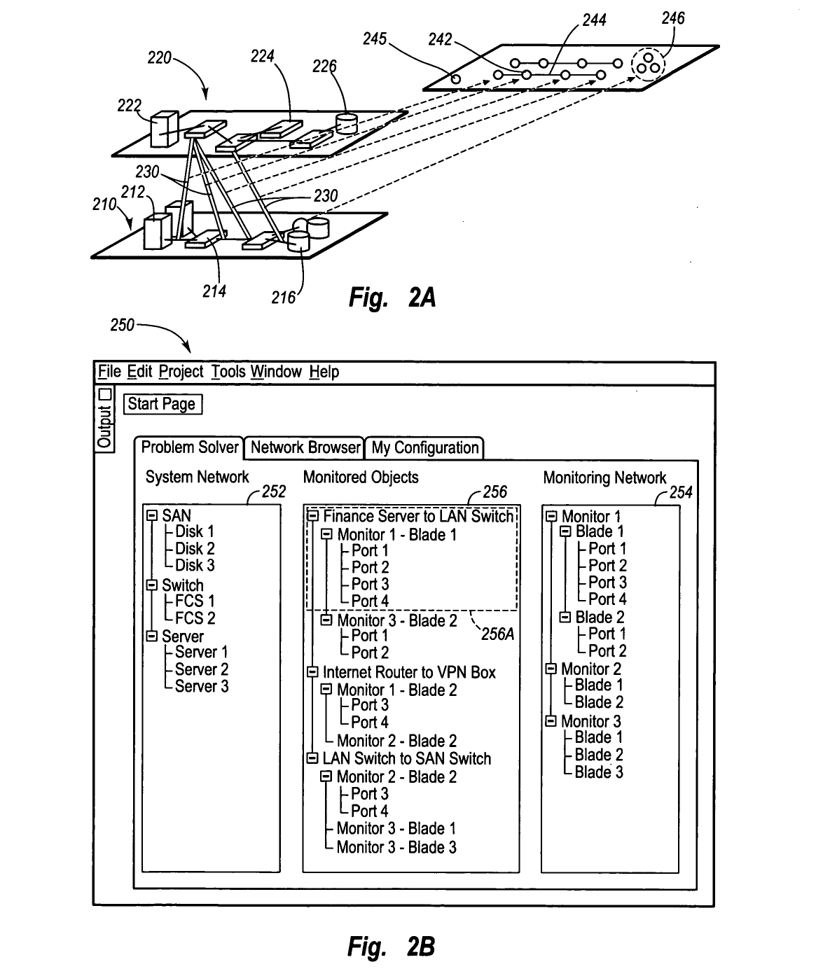

Reference is now made to FIG. 2A, which graphically depicts portions of a communications network in accordance with one embodiment of the present invention. As shown, the system network 210 and monitoring network 220 described in FIG. 1 are graphically depicted. As stated before, in one embodiment, the system network 210 and the monitoring network 220 include portions of the communications network 120. FIG. 2A shows such network portions, wherein the system network 210 includes various network components including, exemplarily, computers 212, switches 214, and storage devices 216. In addition to this, additional or other network components, including software components, can be included in the system network 210.

Similarly, the monitoring network 220 includes various network components as well. The components included in the monitoring network 220 are, in one embodiment, configured to perform various network monitoring and analysis functions. As such, in one embodiment each component of the monitoring network 220 is utilized in accordance with such a purpose. Further, the monitoring network 220 can be connected to the computer system 110 (FIG. 1), which in one embodiment is a network analyzer, in order to cooperate with the network analysis functions thereof.

In accordance with the above, then the monitoring network 220 includes various components, such as a server 222, a blade 224, and a storage device 226. As was the case with the system network 210, other or additional components, including software components, can be included in the monitoring network 220 in addition to those explicitly shown in FIG. 2A.

In accordance with its purpose, the monitoring network 220 is shown in FIG. 2A having various links 230 established between monitoring network components and selected components or component paths of the system network 210. The links 230 between the components of the monitoring network 220 and the components of the system network 210 enable the monitoring network components to analyze data traffic over the portion of the communications network 120 that is represented in system network 210. The links 230 are moveable between components of the monitoring network 220 and components of the system 210 such that various link combinations can be obtained as directed by the network analyzer, such as the computer system 110 of FIG. 1. In this way, proper monitoring analysis of the system network 210 can be achieved.

In accordance with one embodiment, FIG. 2A also shows a monitored objects network, designated at 240. In accordance with one embodiment of the present invention the monitored objects network 240 contains a virtual representation of the links 230 that exist between objects located in the system network 210 and the monitoring network 220.

In detail, various points 242 are shown in the monitored objects network 240. Each point 242 produces a virtual network element, and as such represents a respective link 230 existing between the system network 210 and the monitoring network 220. In addition, various connections 244 are shown in the monitored objects network 240 extending between selected points 242. The connections 244 represent a logical connection chain between various links 230 that together form a data pathway through the system network 210, as shown in FIG. 2A. Thus, it is seen that the monitored objects network 240 is not a physical representation of network components, but rather a logical representation of various links that exist between the monitoring network 220 and the system network 210.

Also shown in the monitored objects network 240 is a potential link point 245. The potential link point 245 is also a virtual network element and represents a potential link that can be achieved between the monitoring network 220 and the system network 210, wherein the link is not currently connected. As such, the potential link point 245 is unconnected by one of the connections 244 to other points 242 in the monitored object network 240. Additionally, a group 245 of potential link points is also shown in the monitored objects network 240. The group 246 is composed of closely related potential link points as virtual network elements that are affiliated together for convenience. By way of example, the group 246 can represent a group of disk drives in a common storage subsystem. In addition to the above, other virtual network elements can be defined by the monitored objects network.

As described above, therefore, the monitored objects network 240 serves as a virtual topography of a portion of a communications network 120, i.e., an amalgam of the system network 210 and the monitoring network 220 with respect to their mutual logical interconnections. It is noted that the representations, or layer identifications, of both the system network 210 and the monitoring network 220 in FIG. 2A are OSI layer 3 identifications, whereas the virtual monitored objects network 240 has an OSI layer 4 identification. This is in accordance with principles of the present invention in that, where a virtual network is derived from constructing connection links between two networks or network portions that are configured according to a specified OSI layer, the derived virtual network representation will acquire a configuration according to a relatively higher-valued OSI layer.

Reference is now made to FIG. 2B, which depicts a graphical user interface (“GUI”) in accordance with one embodiment of the present invention and generally designated at 250. The GUI 250 is a graphical representation of the various network configurations shown in FIG. 2A. As such, the GUI 250 includes a system network representation 252 and a monitoring network representation 254 that textually include the components shown in the system network 210 and monitoring network 220 of FIG. 2A. As such, these representations 252 and 252 depict the physical configuration of the system network and monitoring network.

In addition, the GUI 250 graphically depicts a monitored objects representation 256 corresponding to the monitored objects network 250 of FIG. 2A. The monitored objects representation 256, therefore, includes various textual references corresponding to the points 242 and the connections 244 shown in FIG. 2A. For example, a boxed portion 256A is shown in the monitored object representation 256 and includes text-based references to a “Finance Server” and a “LAN Switch” of the system network 210. In addition, the monitored objects representation portion 256A further shows a “Blade 1,” having ports 1-4, of the monitoring network 220. As mentioned, the Finance Server and the LAN Switch, as well as the Blade 1 and its corresponding ports, are physically represented in the system network representation 252 and the monitoring network representation 254, respectively. Thus, the portion 256A shows a logical link portion existing between the system network components represented in the system network representation 252, i.e., the “Finance Server to LAN Switch,” and the monitoring network components represented in the monitoring network representation 254, i.e., the Blade 1 together with its ports 1-4, thereby presenting a virtual representation of these portions of the communications network (FIG. 1) instead of a physical representation thereof.

The other portions of the monitored objects representation 256 are similarly configured as described in the above paragraph in that the entirety of the monitored objects representation 256 is a textual reflection of a virtual topology as depicted by the monitored objects network 240 of FIG. 2A. In this way, a user can view not only physical configurations of the communications network 120 as depicted by the system network representation 252 and the monitoring network representation 254 of the GUI 250, but also a virtual topology as represented by the monitored objects representation 256, in accordance with one embodiment of the present invention. An analogy can be made between the virtual topography/physical network topology of the present invention and Internet Protocol conventions: in the same sense in which a Uniform Resource Locator (“URL”) can be used as a “virtual” address to direct a computer connection to another computer having a particular IP address and port number, the virtual topography represented by the monitored objects network and corresponding monitored objects representation can be used to assist the user in viewing logical connections within a physical network.

As noted above, the system network 210 and monitoring network 220 are described and represented in FIGS. 2A and 2B in accordance with OSI layer 3, while the monitored objects network 240 and monitored objects representation 256 are represented in accordance with OSI layer 4. This is so as the monitored objects network 240 represented in the GUI 250 by the monitored objects representation 256 is involved in end to end data delivery control, packet delivery supervision, error checking, etc., which are tasks associated with OSI layer 4.

It is therefore appreciated that the graphical representations of GUI 250 of the system network and monitoring network at a given OSI layer can be virtually represented in accordance with another OSI layer by the monitored object network wherein, in one embodiment, the OSI layer representation monitored objects network is at least one integer greater in value than than the OSI layer of the system and monitoring networks. Alternatively, other OSI layers can be represented by the GUI 250, in accordance with the needs of a particular application. As such, one principle the present invention is the creation of virtual network representations regarding a specified OSI layer based on network topologies that are based on connectivity characteristics at another OSI layer, in other words, the construction of a virtual network representation, in one embodiment, regarding a specified OSI layer N+1 based on connectivity characteristics at an OSI layer N.

Not only does the GUI 250 enable virtual representation of portions of the communications network 120 (FIG. 1) to be viewed, but it also enables the logical connections between the system network 210 and the monitoring network 220 to be modified or manipulated according to need. Thus, the GUI 250 serves as one way in which the links 230 between the system network 210 and the monitoring network 220 (FIG. 2A) can be governed. Thus the GUI 250, driven by or cooperating with the application program 130 (FIG. 1), assists a user in evaluating, monitoring, and diagnosing transmission aspects of the communications network 120.

In particular, control over the various links between the system network and the monitoring network can be achieved via the GUI 250 using such user inputs as keyboard entry, mouse clicks, etc. For instance, mouse-clicking on one of the objects denoted in the monitored representation portion 256A will bring up in one embodiment, a list of properties concerning that object. By way of example, a mouse-click or other suitable user input can be executed on the virtual object “Finance Server to LAN Switch” shown in the monitored representation portion 256A of FIG. 2B. This invokes control not only of properties and actions for all of the component sub-elements to the “Finance Server to LAN Switch,” e.g., Blade 1, Port 3, etc., but also the supra- or meta-properties and actions for the entire virtual construction. An example of a supra-property is total, whole-path throughput or total, whole-path statistical summaries. In this or similar way, information about or modification of the properties of an object or its corresponding links can be achieved.

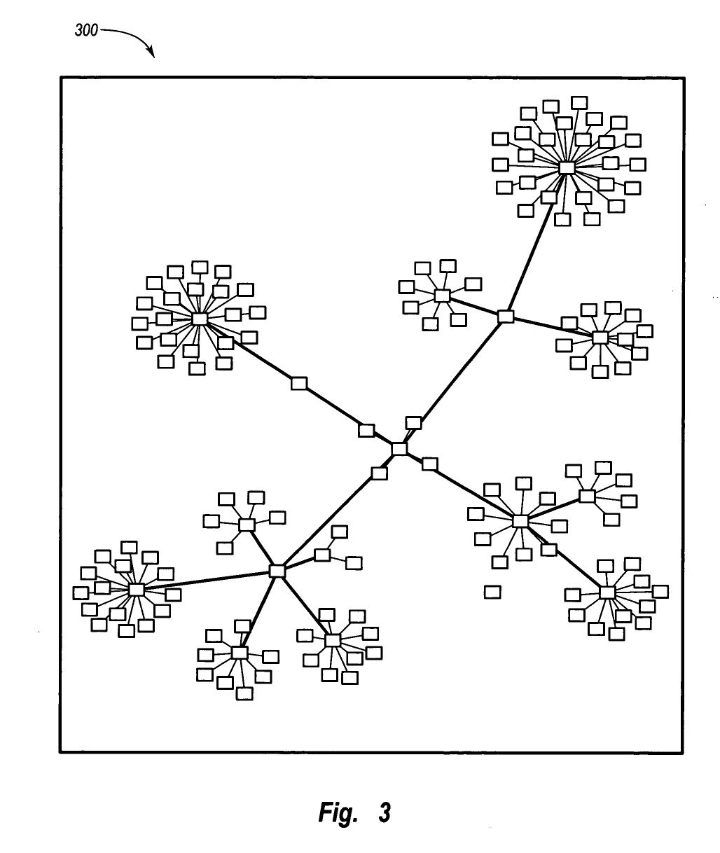

Reference is now made to FIG. 3, which depicts a virtual network topology configured in accordance with one embodiment of the present invention. It is noted that the virtual topology virtual network topology as depicted by the monitored objects representation 256 in FIG. 2B is configured in a tree structure. In some network configurations, however, a more complicated network configuration exists. As such, other graphical schemes can be employed in order to simplify the graphical aspects of the virtual network topology. FIG. 3 shows one example of this, wherein a monitored objects representation 300 is shown having a multiple hub and spokes configuration. Thus, this and other graphical representations can be used in order to graphically depict the virtual network topology as a GUI. In one embodiment, such graphical GUI representations can be implemented using a NET Studio™ computer language produced by Microsoft, Inc.

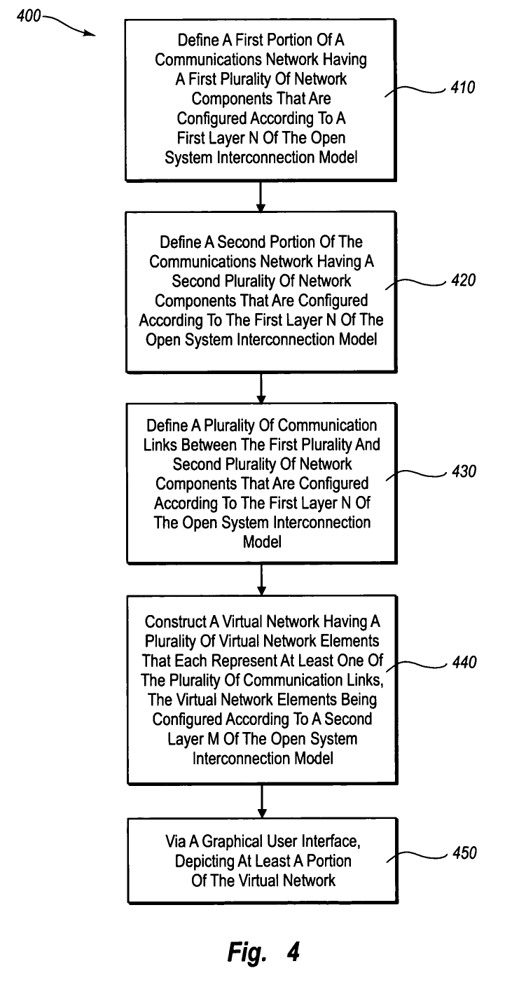

Reference is now made to FIG. 4, which depicts various stages in a method, generally designated at 400, of representing a plurality of network components that are interconnected via a communications network, such as the configuration shown in FIG. 2A. The method 400 includes block 410, in which a first portion of a communications network is defined having a first plurality of network components that are configured according to a first layer N of the OSI Model. In block 420, a second portion of the communications network is defined having a second plurality of network components that are configured according to the first layer N of the OSI Model. In block 430, a plurality of communication links between the first plurality and the second plurality of network components that are configured according to the first layer N of the OSI Model are defined. A virtual network having a plurality of virtual network elements is constructed in block 440, wherein each virtual network element represents at least one of the plurality of communication links, the virtual network elements being configured according to a second layer M of the OSI Model. Finally, in block 450 a graphical user interface depicting at least a portion of the virtual network is created.

With respect to computing environments, communications networks, and related components in general, at least some embodiments of the present invention may be implemented in connection with a special purpose or general purpose computer that is adapted for use in connection with communications systems. Embodiments within the scope of the present invention also include computer-readable media for carrying or having computer-executable instructions or electronic content structures stored thereon, and these terms are defined to extend to any such media or instructions for use with devices such as, but not limited to, link analyzers and multi-link protocol analyzers.

By way of example, such computer-readable media can include RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, or a combination of hardwired or wireless) to a computer or computing device, the computer or computing device properly views the connection as a computer-readable medium. Thus, any such connection is properly termed a computer-readable medium. Combinations of the above should also be included within the scope of computer-readable media. Computer-executable instructions comprise, for example, instructions and content which cause a general purpose computer, special purpose computer, special purpose processing device, such as link analyzers and multi-link protocol analyzers, or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

A computer system as described herein can include a processing unit, a system memory, and a system bus that couples various system components including the system memory to the processing unit. The computer system is connectable to networks, such as, for example, an office-wide or enterprise-wide computer network, an intranet, and/or the Internet. The computer system can exchange data with external sources, such as, for example, remote computer systems, remote applications, and/or remote databases over such a network.

The computer system can also include a network interface through which it receives data from external sources and/or transmits data to external sources. The network interface facilitates the exchange of data with a remote computer system via a link. The link represents a portion of a network, and the remote computer system represents a node of the network.

Modules of the present invention, as well as associated data can be stored and accessed from any of the computer-readable media associated with the computer system. For example, portions of such modules and portions of associated program data may be included in an operating system, application programs, program modules and/or program data, for storage in a system memory. When a mass storage device, such as a magnetic hard disk, is coupled to the computer system, such modules and associated program data may also be stored in the mass storage device. In a networked environment, program modules and associated data depicted relative to the computer system, or portions thereof, can be stored in remote memory storage devices, such as, for example, system memory and/or mass storage devices associated with a remote computer system. Execution of such modules may be performed in a distributed environment as previously described.

The present invention may be embodied in other specific forms without departing from its spirit or essential characteristics. The described embodiments are to be considered in all respect only as illustrative, not restrictive. The scope of the invention is, therefore, indicated by the appended claims rather than by the foregoing description. All changes that come within the meaning and range of equivalency of the claims are to be embraced within their scope.

1. A method of producing a virtual topography of a communications network, comprising:
defining a first portion of a communications network having a first plurality of network components that are configured according to a first layer N of the Open System Interconnection model;
defining a second portion of the communications network having a second plurality of network components that are configured according to the first layer N of the Open System Interconnection model;
defining a plurality of communication links between the first plurality and the second plurality of network components that are configured according to the first layer N of the Open System Interconnection model; and
constructing a virtual network having a plurality of virtual network elements that each represent at least one of the plurality of communication links.

2. A method of producing as defined in claim 1, wherein constructing the virtual network further comprises:
constructing a virtual network having a plurality of virtual network elements that each represent at least one of the plurality of communication links, the virtual network elements being configured according to a second layer M of the Open System Interconnection model.

3. A method of producing as defined in claim 1, further comprising:
via a graphical user interface, depicting the virtual network elements of the virtual network on a display device.

4. A method of producing as defined in claim 3, wherein depicting the virtual network elements further comprises
depicting the virtual network elements of the virtual network such that a user can initiate actions for the first and second portions of the communications network.

5. A method of producing as defined in claim 4, wherein the user can initiate actions regarding statistical summaries of the network components of the first and second portions of the communications networks.

6. A method of producing as defined in claim 1, wherein the method is executed in connection with a network analyzer.

7. A method of producing a virtual topography of a communications network, comprising:
defining a first portion of a communications network having a first plurality of network components that are configured according to a first layer N of the Open System Interconnection model;
defining a second portion of the communications network having a second plurality of network components that are configured according to the first layer N of the Open System Interconnection model;
defining a plurality of communication links between the first plurality and the second plurality of network components that are configured according to the first layer N of the Open System Interconnection model; and
constructing a virtual network having a plurality of virtual network elements that each represent at least one of the plurality of communication links, the virtual network elements being configured according to a second layer M of the Open System Interconnection model.

8. A method of producing as defined in claim 7, further comprising:
via a graphical user interface, depicting at least a portion of the virtual network.

9. A method of producing as defined in claim 8, further comprising:
enabling a user to modify properties of the virtual network elements via the graphical user interface.

10. A method of producing as defined in claim 7, wherein the value of layer M is greater than the value of layer N.

11. A method of producing as defined in claim 10, wherein the value of layer M is an integer value “1” greater than the value of layer N.

12. A method of producing as defined in claim 7, wherein defining a first portion further comprises:
defining a first portion of a communications network having a first plurality of network components that are configured according to a first layer N of the Open System Interconnection model, the first plurality including computers, network switches, and storage devices.

13. A method of producing as defined in claim 7, wherein defining a second portion further comprises:
defining a second portion of the communications network having a second plurality of network components that are configured according to the first layer N of the Open System Interconnection model, the second plurality including network monitoring components.

14. A method of producing as defined in claim 7, wherein the virtual network defines a logical path through at least one of the first and second portions of the communications network.

15. A computer program product for implementing a method of producing a virtual topography of a communications network, the computer program product comprising:
a computer readable medium carrying computer executable instructions for performing the method, the method comprising:
defining a first portion of a communications network having a first plurality of network components that are configured according to a first layer N of the Open System Interconnection model;
defining a second portion of the communications network having a second plurality of network components that are configured according to the first layer N of the Open System Interconnection model;
defining a plurality of communication links between the first plurality and the second plurality of network components that are configured according to the first layer N of the Open System Interconnection model;
constructing a virtual network having a plurality of virtual network elements that each represent at least one of the plurality of communication links, the virtual network elements being configured according to a second layer M of the Open System Interconnection model; and
via a graphical user interface, depicting at least a portion of the virtual network.

16. A computer program product as defined in claim 15, wherein the network components of the second portion of the communications network includes a plurality of network monitoring components for monitoring the network components of the first portion.

17. A computer program product as defined in claim 16, wherein properties of the network components of the first and second portions of the communications network can be modified via the graphical user interface that depicts at least a portion of the virtual network.

18. A computer program product as defined in claim 17, wherein the plurality of network monitoring components and network components include hardware and software components.

19. A computer program product as defined in claim 18, wherein defining a plurality of communication links further comprises:
defining a plurality of communication links between the first plurality and the second plurality of network components via the graphical user interface.

20. A computer program product as defined in claim 19, wherein the virtual topography is graphically depicted in a tree structure.
